(19) United States
(12) Patent Application Publication
(10) Pub. No.: US 2010/0277077 A1
(43) Pub. Date: Nov. 4, 2010

(54) Apparatus and method to enhance the life of Light Emitting diode (LED) devices in an LED matrix

(76) Inventors: Man Hay PONG, Hong Kong (CN); Tan Fung LI TAM, Hong Kong (CN)

Correspondence Address: M.H. Pong, Flat G, 1st Floor, Tower 13A,, South Horizons, Apleichau, Hong Kong, omitted

(21) Appl. No.: 12/765,895

(22) Filed: Apr. 23, 2010

Related U.S. Application Data
(60) Provisional application No. 61/175,055, filed on May 4, 2009.

(51) Int. Cl. H05B 37/02

(52) U.S. Cl. 315/152; 315/294

(57) ABSTRACT

The present invention is an apparatus to enhance the Life of LED devices in an LED matrix for illumination. It comprises of a spare LED matrix in addition to a main LED matrix. It further comprises of a constant current source which is the power source. Such constant current source is coupled directly to said main LED matrix and powers it up accordingly. In adverse conditions, say when the ambient temperature is high, continuous operation of said main LED matrix at full power will deteriorate the LED life. A power converter coupled to said constant current source operates and draws current to power on said spare LED matrix. This relieves said main LED matrix from full power and the reduction in illumination is largely compensated by said spare LED matrix. This invention further comprises a controller which senses temperature and other parameters and operates said spare LED matrix intelligently. The present invention is also a method to operate said apparatus to maximize LED life or to maximize illumination.

### FIELD OF THE INVENTION

The invention generally related to apparatus and method to enhance the life of Light Emitting diode (LED) devices in an LED matrix.

### BACKGROUND OF THE INVENTION

Light emitting diodes provide superior operating life compared to traditional artificial lighting sources. Life of an LED lamp with a plurality of LED chips is generally established by the time lasts for a certain percentage of its LED chips to decay to a certain percentage of their original luminous flux. Present commercialized product is able to guarantee a life (typically 60000 hours) that specifies operation at a typical power and a typical temperature, whereby 90% of the chips would maintain 70% luminous flux. The problem is raised that when an LED lamp is operated outside the designed operating region especially at high temperature, the life would drop dramatically and the lighting efficacy would reduce. For example, expected life of a typical InGaN type 3 watt LED reduces from 60000 hours to 10000 hours when the junction temperature is increased from 130 degree C. to 150 degree C., operated at 1A. This is a six fold reduction in life time for a mere 20 degree C. increase in temperature. Typical chip package provides 8-20 K/watt junction to thermal pad radiation. Normal aluminum heatsink provides 20-35 K/watt thermal radiation, if the ambient temperature is high it is quite possible that the LED is forced to operate at such high temperature.

Research works are carried out to resolve the problem and many are oriented to enhance thermal radiation. One way is to improve mechanical heatsink design and package design for better thermal dynamic radiation. A direct way is to increase heatsink size or increase the area of the heat sink fins. This inevitably increases product size and weight, and more often cost as well. Innovative heatsink shapes invented by Newby is example of this scheme. (U.S. Pat. No. 6,999,318)

Another attempt to improve thermal transfer is adding an electric fan to improve heat transfer between the heatsink and ambient. It is a common practice to cool electronics equipment. However, it is not suitable to adapt to LED lamp. Fans have mechanical moving part and its reliability is far lower than the LEDs. Sometimes the LED lamp is placed for outdoor lighting, dust and other possible vibration would deteriorate the fan. It is expected the fan would break down before the LED. In U.S. Pat. No. 7,438,439 Nakano applies a cooling fan to cool the LED and a heater to heat the LED to keep the temperature stable. It is an example of this art.

Other ways focus on the LED chip itself. To improve the thermal radiation manufacturers worked on the package design. The idea is to reduce the thermal resistance between junction to the device thermal pad. This method gave appreciable result. The junction to thermal pad thermal resistance has been reduced from 30 K/W in old 5 mm round type small power LED to 15-8 K/W in high power SMD packages. However, this process took 30 years to develop. No matter how well the package thermal resistance can be reduced, the overall performance is still limited by the heat sink. Despite the operating power, ambient temperature and are other effects may affect the junction temperature, and its effect is dynamic. If the heatsink or other heat dissipative method is designed with the worst case, it may be overdesigned for most operation situation.

Besides thermal dynamic improvement, effort was done to improve the material of the LED core. The industry has been improving the efficacy of LEDs so that less power is dissipated for the same lumen. The efficacy improved from 0.5 lm/w in 1960 to over 100 lm/w in year 2008. This is related to advancement of the solid state technology. This is the ultimate solution but such quantum improvement often takes a very long time and huge investment. Also, when the efficacy is improved, the potential application of LED is widened. Industry would produce higher power and lumen chips that occupy the same space and keep increasing the volumetric power of LED lamp. For example the per chip power has increased from 0.05 w in 1970 to 10 w in 2007. Therefore no matter how good the solid state technology advance the problem still exists.

Using chemically synthesized high temperature tolerate material is another means to improve LED. However these chips require more advanced manufacturing technology, products on the market are much more expensive. Similar to the previous case, better temperature tolerate LED means the lamp may be installed in environment with higher temperature and the problem is still exists.

Some operating schemes protect LED from fast decaying. They aim at modifying the operating point of LED, for example turn off or dimming the lamp by reducing its power when it is overheated. These schemes are oriented to maintain the life, but brightness is sacrificed. Also, it is a fact that the efficacy of LED reduce as temperature increase. These solutions cannot adapt in the cases that the overall brightness is needed to be maintained.

The present invention is oriented to provide a solution to enhance the life and luminous at high operating temperature in an electrical mean. PRIOR ART applied this principle can be clarified into two methods. The first one is reducing the electric current supplied to the light emitting diode when the temperature is high. This method scarifies the light intensity and more complex driver is required. Also a sensor is required to link to the driver. Yang Ta-yung's invention (U.S. Pat. No. 7,286,123) and Joung's invention in U.S. Pat. No. 7,330,002 typically represents this idea. It requires more complex source driver and sensors have to link to the driver. It is not practicable in some cases of road lamps. Therefore it is only suggested for back light LED by the inventor. Weindorf's invention in U.S. patent publication US2002/0135572 balances the performance of LED placed in parallel, but the control is connected to the driver source and life and luminous cannot be enhanced. The second method is increasing the power supplied to the LED to maintain the luminous flux, but it would further shorten the life of the LED. Wu Chen Ho's invention (U.S. Pat. No. 6,111,739) represents this method.

At present most LED lamps are driven by constant current source drivers. An LED driver controls the current flow through the LED, or LED matrix to suit the diode property of LED. The current versus voltage characteristic of one LED chip changes with temperature and time. When the temperature is high, the current increases while the voltage maintain. If a constant voltage source is not suitable because the LED current increases as it is heating up itself. The increased current leads to increasing power and further heat up the LED. This “positive feedback” may loop the diode to a high current high temperature operating point. Also, no two semiconductor devices are identical. When two LED are connected in parallel, the one with higher current heats up first and it takes higher current. It would decay much faster than the other one. Therefore in order to drive the LED properly and to balance the chips in a matrix a constant current drive is usually applied in practice. Output current like 350 mA and 700 mA are typical for medium to high power LED lamp (˜10 -20 Watts). 1 A and 1.5 A driver can be found for higher power ones. (15-30 Watts) Constant current source drivers can also avoid the voltage drop effect of wiring. In practice the wiring resistance may vary in different installations. Constant current source driver can maintain a preset current regardless of the amount of wiring resistance.

Another fact is LED lamp is usually implemented by a matrix of LED chips. Since the per chip power of LED manufactured by mature technology is still low, LED can be put together to produce higher luminance. The matrix is usually LEDs packed in serial, therefore the operating voltage can be increased and the step down ratio of the converted can be lowered and the conversion efficiency can be improved. These LEDs serials may be placed in parallel but it is not mandatory. For example, driving 2 serials of 350 mA LED with a 700 mA driver. This practice is more common for low power chips or the driving current is high, in order to reduce the number of drivers.

In practice, LED drivers may be placed far away from the LED lamps, especially for road lighting. Therefore it is not easy to transmit the temperature information at the lamp and other data to the driver far away. Examples of such LED installation include domestic lighting, subway lighting and public transportation lighting.

### SUMMARY OF THE INVENTION

The present invention can significantly enhance the life of LED chips and LED lamps that operates at high temperature. The invention comprises of a set of controllable spare LEDs to share the current of the main LED matrix drive by a constant current source and reduce the main LEDs' junction temperature. Converter circuit, controller and sensor is included to enable the spare LED to work in the desired operating region

The invention comprises of a set of spare LEDs chip powered by a converter in parallel to an LED matrix. It further comprises of a controller that receives feedback from the temperature sensors on the thermal pad of the lamp. The controller calculates the expected life. The controller can be implemented by an MCU, FPGA, analogue IC or other integrated circuit means. While the temperature rises and the expected life of the LED matrix may fall below the specified time span, the controller turns on the spare LED matrix. Current is then branched to the converter and current flows through the main LED matrix will be reduced. The junction temperature will also reduce instantly and the life can be lengthened. The reason to implement a buck converter is to provide accurate control of the power delivery to the spare LED. The operation point of the main LED matrix can be tuned for long life while the spare LED compensate for the drop in brightness of the main LED matrix and preserve overall illumination. The converter also prevents the spare LEDs from over voltage, due to the imperfect transient response of the LED drivers. During the voltage changes from the main LED matrix to the spare LED matrix to fit the constant current, the instantaneous high voltage from the current source would deteriorate the spare LEDs.

The invention can greatly enhance life the LED, especially those operated outside the designed operating temperature. For example, in a case where 6 typical LED chips with 13 K/W thermal pad is packed together with a 30 K/W heatsink and a 2 LED chips serial is paralleled as the spare ones, the life can be enhanced from 10000 hr to 60000 hr.

The present invention can be implemented in conventional LED lamps without major change. The apparatus is driven by a conventional constant current LED driver with no additional power supply. No extra connection between the lamp and the driver is required. No modification to the drivers or application design is required. No matter where the lamp is physically placed, the invention can suit the application.

Unlike the solution by using bigger heatsink, the apparatus of the present invention requires a small space to implement. It fits right into the lamp compartment. Since the apparatus of the present invention is intelligent with a processor, it can be adapted flexibly to avoid over stressing the LEDs even in extreme cases. It can be implemented with common LED chips. It has no mechanical moving part which impairs reliability. The invention can instantly adapt with the state of the art high temperature high power LEDs or common lighting class LEDs, so the LEDs can work fine in their own territories continuously, with enhanced life time and extra protection.

Brightness can be maintained and controlled so it does not suffer from light reduction, compare to the traditional switching off scheme. Plus the feature that it does not require replacing the mature constant current driver with a tailor made variable current source.

### BRIEF DESCRIPTION OF THE DRAWINGS

FIG. 1 illustrates the embodiment of tradition temperature compensated LED circuit

FIG. 2 illustrates the general embodiment of the present invention in a block diagram

FIG. 3 illustrates the possible arrangement of light emitting diode to form a matrix

FIG. 4 is the circuit of the converter circuit where a buck converter is applied

FIG. 5 is the circuit of the converter circuit where a flyback converter is applied

FIG. 6 is the circuit of the converter circuit where a regulator is applied

FIG. 7 is the algorithm to operate the apparatus to enhance life

FIG. 8 is the typical flow to apply the algorithm in FIG. 7

FIG. 9 is the algorithm to operate the apparatus to enhance luminous flux

### DETAILED DESCRIPTION OF THE PREFERRED EMBODIMENTS

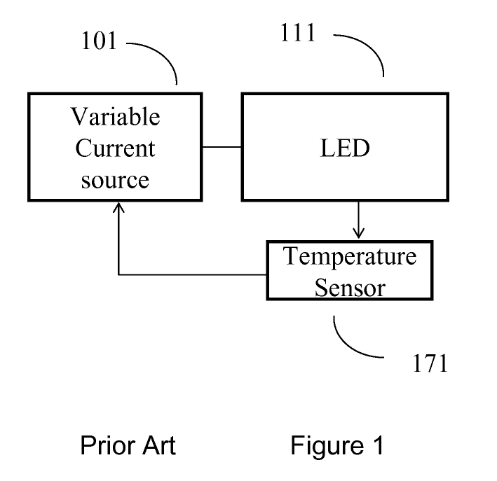

The prior art setup of temperature compensated LED apparatus is illustrated in FIG. 1. LED 111 is powered by a variable current source 101. Temperature sensor 171 senses the temperature of the LED and feedback a signal to the current source 101. The current source adjusts the supply current to the LED. Many researchers teach how to build the feedback circuit, the hardware design of the sensing equipment and the controlling algorithm. These solutions have a common point. The sensor 171 must be placed near to LED 111 to sense correctly, and the feedback signal from the sensor must be connected to the current source 101. There are two limitations. First the feedback line must be long if the LED 111 is placed far from the current source 101, or the current source 101 would be heated up by LED 171 if there are placed close to each other. Second a variable current source is more complex than a constant current source.

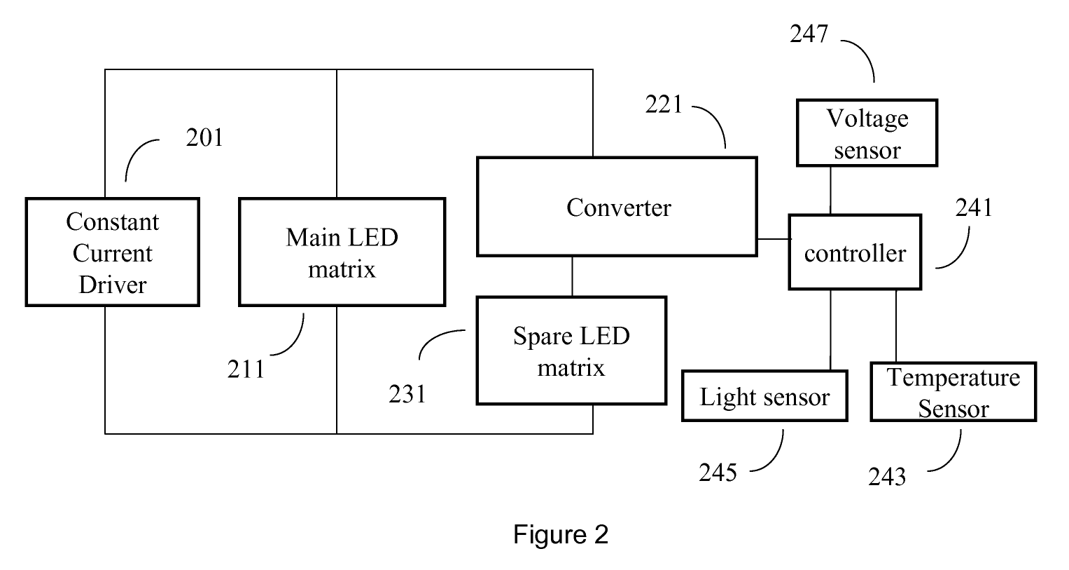

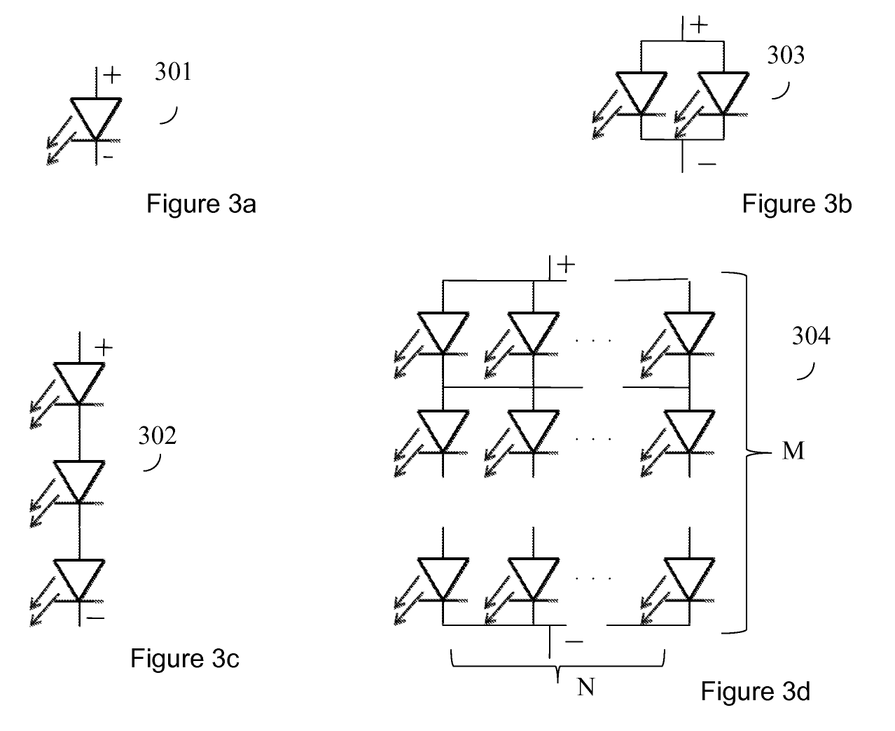

A basic embodiment of the present invention comprises of four subparts as shown in FIG. 2. The first subpart is a set of LED matrix (main LED matrix) 211, which consists of at least one light emitting diode. The matrix can be formed by multiple LEDs connected in series or in parallel each set having a positive terminal or negative terminal. The number of combinations is unlimited, typical examples are shown in FIGS. 3. The examples in FIGS. 3 includes a 1×1 LED matrix (301), a 3×1 serially connected matrix (302), a 1×2 parallel connected matrix (303) and an N×M mixed serially and parallel connected matrix (304). This subpart is the main luminary of light emitting diode based lighting equipment. If the ambient temperature is raised or other reason the LEDs may be overheated and the life may deteriorate. The second subpart in FIG. 2 comprises a constant current source driver 201, it is the source of energy which provides constant current to the light emitting diode. The driver may be implemented by analogue or digitally controlled electrical elements which keep the output current constant. A third, fourth and fifth subpart of the present invention provide protection to the main LED matrix 211 and maintain the luminous flux. The third subpart is a spare LED matrix 231. Its formation consists of at least one light emitting diode. Its rated power can be lower, the same as or higher than the main LED matrix 211. The spare LED matrix 231 is powered by a fourth subpart, a DC to DC converter 221. The converter 221 may be a buck, flyback converter or other DC to DC converter and regulator. Converter 221 draws power from the constant current driver directly. The fifth subpart is controller circuit 241 that controls the operation of the spare LED matrix 231. At least one temperature sensor 243 is included in the converter circuit to sense the thermal pad temperature of the LED matrix.

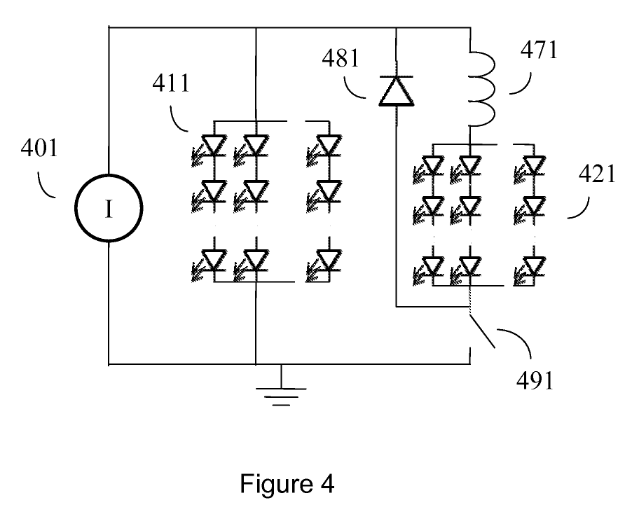

FIG. 4 illustrates a typical setup of the system explained above where a buck converter is adapted the said DC to DC converter. Constant current source 401 supplies power to main LED matrix 411. Inductor 471, diode 481 and switch 491 are components of the buck converter. Switch 491 turns on and off at a high frequency to control the power flow to a spare LED matrix 421. The buck converter is also powered by the constant current source 401. In the system level as illustrated by FIG. 2, controller 241 would control switch 491 in order to adjust the power delivered to the spare LED matrix 421.

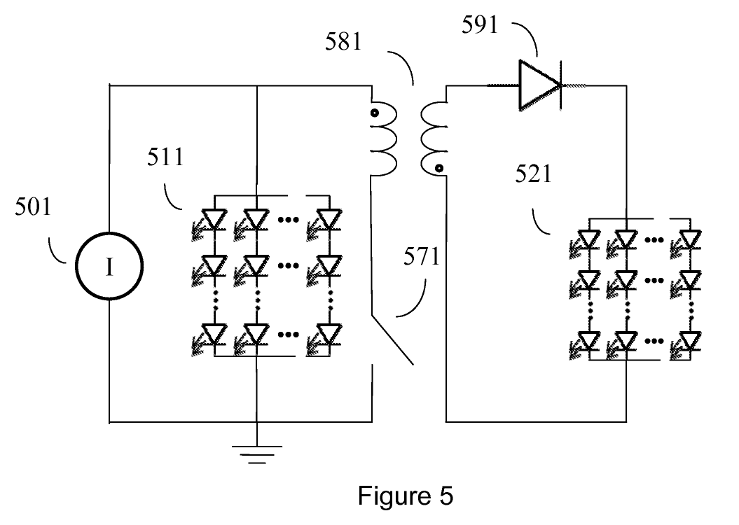

FIG. 5 illustrates a typical setup of the basic embodiment described above where a flyback converter is adapted as the said DC to DC converter. Constant current source 501 supplies power to main LED matrix 511. Coupled inductor 581, diode 591 and switch 571 are components of the flyback converter. Switch 571 turns on and off at a high frequency to control the power flow to a LED matrix 521. The flyback converter is also powered by the constant current source 501. In the system level as illustrated by FIG. 2, controller 241 would control switch 571 in order to adjust the power output of the spare LED matrix 521.

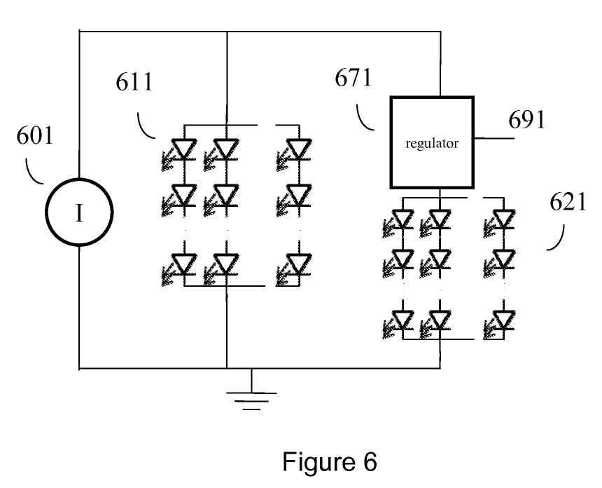

FIG. 6 illustrates a typical setup of the basic embodiment described above where a regulator is adapted. Constant current source 601 supplies power to main LED matrix 611. A regulator 671 is powered by the constant current source 601 and provides power to a spare LED matrix 621. Regular 671 has a control terminal 691 which is coupled to controller 241 in the system level as illustrated by FIG. 2. Controller 241 controls the terminal 691 of the regulator in order to adjust the power output of the spare LED matrix 621.

General operation of the present invention is described herein with reference to FIG. 2. When temperature is sensed high by temperature sensor 243, controller 241 commands converter 221 to power on spare LED matrix 231. Constant current so produced by constant current driver 201 will be diverted by said spare LED matrix 231 and current flows through the main LED matrix 211 can be reduced. Current delivery to said spare LED matrix 231 and required light intensity of the spare LED 231 would be determined by an algorithm described in this document.

A control algorithm for the spare LED matrix is explained herein. To describe the algorithm, performance parameters including life, reliability, temperature and light intensity should be known. The methods to obtain this data are explained below.

The junction temperature can be determined by

T_{junction}=T_{Thermal Pad}+P_{LED}×R_{Pad-junction}

T_{Thermal Pad} is the thermal pad temperature sensed by temperature sensor. R_{Pad-junction} is the thermal pad to junction temperature, given by the manufacturer or obtained by experiment P_{LED} is the power flows through one LED, which can be obtained by two methods. The first method is by voltage sense across said main LED matrix 211. Power P_{LED} is the voltage across one LED times the current. The voltage is sensed by the voltage sensor, divided by the number of LED in one series. The current can be determined from a look up table, or by a current to voltage equation. The current to voltage relationship is always provided by the LED manufacturer, and it can be easily obtained by experiment. The second method is measuring the voltage and current across one LED of the system verse different controller duty and thermal pad temperature. Utilize the obtained information to produce a lookup table.

The relationship between life, reliability and temperature can be found from data provided by the LED manufacturer. The information can be hardcoded as a look up table, or they can be summarized by two equations.

R(a)=exp(−λt)

λ=C×exp(K/T)

where t is the life, λ is reliability constant, C and K are constant that can be determined by manufacturer data or statistic data and T is the junction temperature.

The relationship between light flux, current and temperature can be obtained from manufacturer's data or by experiment with varying current and temperature. It can be hardcoded as a look up table or summarizes the following equation,

φ [symbol] _{|} [symbol] =K

[symbol]

[symbol]

φ [symbol] _{|} [symbol] =K_{T}×

[symbol]

where φ is the relative light flux, K₁, K_{T}, m are constant and T_{C} is temperature dependence. With these equations, the controller of the converter circuit is able to figure out the light flux, predicted life and reliability from the information sensed by the temperature sensor. It founded the base to the control algorithm.

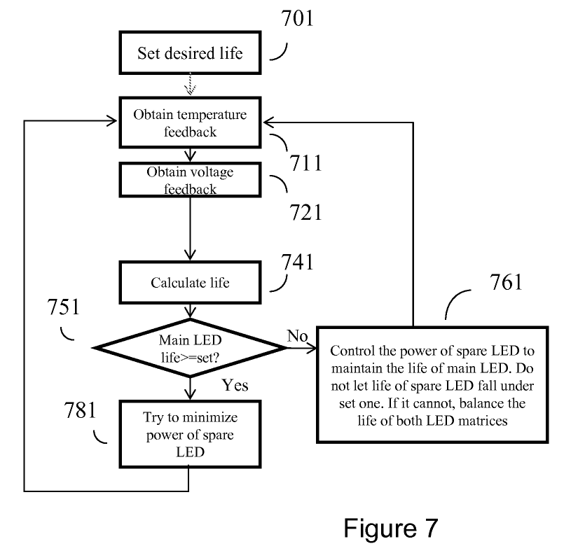

The present invention is a method that enhances life, reliability and luminous flux of LEDs using the said principles. This method employs an algorithm which can maintain life or maintain light intensity, or a combination of both with different weighting. The algorithm can be set to enhance life. Such algorithm flowchart is shown in FIG. 7. A desired life time is set in step 701. The controller runs a closed loop feedback system. In each loop, the controller checks the environmental parameter like temperature and LED voltage in steps 711 and 721. The next step is to calculate the performance parameters included life, luminous flux and temperature in step 741. In the feedback loop 751, the algorithm compares the set and calculated life. If the calculated life of the main LED matrix is longer than the set life, the controller should minimize the power of the spare LED 231. If the calculated life of the main LED matrix is shorter than the set life, the controller 241 controls the spare LED 231 to share power of the main LED matrix and enhance the life of main LED matrix while not reduce the life of the share LED to the set one. This step is illustrated as 781 in FIG. 7. In case the life of both LED matrices cannot be maintained, which may happen in cases say the ambient temperature is too high whereby both LED matrices cannot maintain their expected lifetimes as set in step 701, step 761 directs the controller to balance the life between both LED matrices such that operating the LED matrices at a point that both LED matrices have the same life.

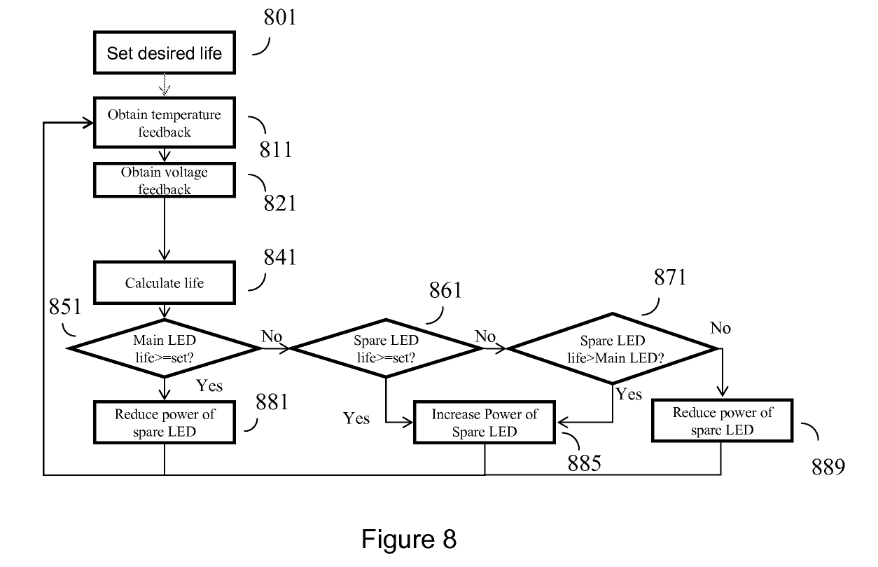

FIG. 8 further elaborates step 761 in the algorithm in FIG. 7. Steps 801, 811, 821, 841, 851 are identical to steps 701, 711, 721, 741, 751 respectively. Operation through theses steps are the same as that described earlier. When LED temperature is increased to a level that the life of main LED matrix 211 cannot maintain, the controller compares the calculated life of the spare LED matrix with set one in step 861. If the calculated life of the spare LED matrix is longer that the set one, the controller increases the power of the spare LED matrix in step 885. Then the power consumed by the main LED matrix should reduce and drawn to the spare LED matrix. If the calculated life of the spare LED matrix is shorter that the set one, the controller compares the life of the spare LED matrix with main LED matrix in step 871. If the life of the spare LED matrix is longer that the main LED matrix, the controller increases the power of the spare LED matrix in step 885. If it is not the controller reduces the power of the spare LED matrix in step 889. Therefore the life of both LED matrices can be balanced.

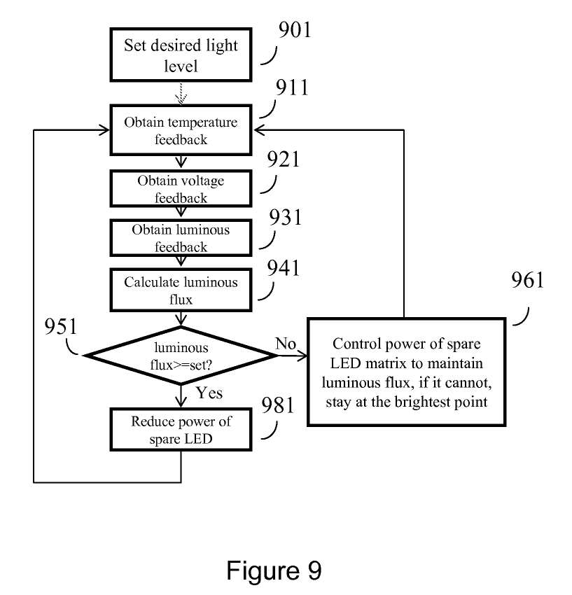

The present invention also comprises of a further algorithm to maintain luminous flux. Such algorithm flowchart is shown in FIG. 9. A light flux level is set in step 901. The controller 241 runs a closed loop feedback system. In operation, the controller checks the environment in step 911 and 921. In step 931 the overall luminous feedback is sensed. Then the controller calculates the luminous flux emission in step 941. In the step 951, the algorithm compares the set and calculated light flux level. If the emitting flux of the overall illumination is higher than the set flux level, the controller would reduce the power of the spare LED 231. If the emitting flux of the main LED matrix is lower than the set level, the controller 241 operates the spare LED 231 to try to compensate the flux level. If there is a case where the spare LED matrix is not sufficient to compensate the flux level, the controller operates the spare LED matrix in such a way to produce the maximum overall luminous flux in step 961.

The life extension potential is infinite. In a typical case the life of a 6×1 LED matrix can be extended from 10000 hour to 60000 hour by adding a 2×1 spare LED matrix.

The present invention is not to be limited in scope by the specific embodiments described herein, which are intended as single illustrations of individual aspects of the invention, and functionally equivalent methods and components are within the scope of the invention. Indeed, various modifications of the invention, in addition to those shown and described herein will become apparent to those skilled in the art from the foregoing description and accompanying drawings. Such modifications are intended to fall within the scope of the appended claims.

What is claimed is:

1. An apparatus to enhance life and reliability of a light emitting diode matrix comprising :
A main light emitting diode matrix, comprising at least one light emitting diode;
A power source which delivers constant current coupled to and power on said main light emitting diode matrix;
A spare light emitting diode matrix, comprising at least one light emitting diode;
A DC to DC power converter which draws power from said power source to reduce power delivery to said main light emitting and delivers power to said spare light emitting diode matrix in a controlled manner;
A controller coupled to said DC to DC power converter which controls power delivery to said spare light emitting diode matrix.

2. Apparatus in claim 1 further comprising:
At least one temperature sensor which senses temperature of said main light emitting diode matrix in claim 1.

3. Apparatus in claim 2 further comprising:
At least one temperature sensor which senses temperature of said spare light emitting diode matrix in claim 1.

4. Apparatus in claim 3 further comprising:
At least one voltage sensor which senses voltage output of said power source in claim 1.

5. Apparatus in claim 4 further comprising:
At least one light sensor which senses total luminous flux produced by said LED matrices in claim 1.

6. A method to enhance life of a light emitting diode matrix by operating on apparatus in claim 5 comprising the following steps:
set desired life of said main light emitting diode matrix;
said controller receives data from said temperature sensor;
said controller controls power delivery to said spare LED matrices.

7. Method in claim 6 to enhance life of a light emitting diode matrix by operating on apparatus in claim 5 further comprising the following steps:
said controller receives data from said voltage sensor;
said controller receives data from said light sensor;
said predicts life of said light emitting diode matrices.

8. Method in claim 7 further comprising the following steps:
said controller compares said predicted life of said main LED matrix with said set value;
keep said spare LED matrix off if the predicted life of said main LED matrix is longer than said set value;
increases the power output to said spare LED matrix if said predicted life of the main LED matrix is shorter than said set value and said predicted life of the spare LED matrix is longer than said set value;
keep said spare LED matrix unchanged if said predicted life of the spare LED matrix is equal to said main LED matrix;
reduces power output to said spare LED matrix if the predicted life of said main LED matrix is shorter than said set value and the predicted life of said spare LED matrix is shorter than said set value, and the predicted life of said spare LED matrix is shorter than said main LED matrix;

9. A method to maintain luminous flux of a light emitting diode matrix by operating on apparatus in claim 5 comprising the following steps:
set desired lighting flux of said LED matrices;
compare lighting flux emitting by said main LED matrix to said set value;
reduce power delivery to said spare LED matrix if the luminous flux of said main LED matrix is higher than said set value;
operate said spare LED matrix to compensate luminous flux if the luminous flux of said LED matrices is lower than said desired value;
maintain the LED matrices at the highest luminous level if the luminous flux of said LED matrices cannot reach said desired value.
